(19) United States
(12) Patent Application Publication
(10) Pub. No.: US 2025/0237317 A1
(43) Pub. Date: Jul. 24, 2025

(54) SAFETY DEVICES, LOCKING ASSEMBLIES, FLUID ENDS, AND RELATED METHODS FOR PUMPING OPERATIONS

(71) Applicant: FORUM US, INC., Houston, TX (US)

(72) Inventors: Sohaib ANWER, Houston, TX (US); Stephen PATTERSON, Westhill (GB); Francis SANTOS, San Antonio, TX (US); Blake E. SMITH, College Station, TX (US); Paul NGUYEN, Cypress, TX (US)

(21) Appl. No.: 18/416,746

(22) Filed: Jan. 18, 2024

(51) Int. Cl. F16K 27/12; F16K 27/02

(52) U.S. Cl. CPC F16K 27/12; F16K 27/0263

(57) ABSTRACT

The present disclosure relates to safety devices, locking assemblies, fluid ends, and related methods for pumping operations. One safety device for fluid ends includes a valve cover including an outer shoulder and a receptacle opening, and a jam structure movable in the receptacle opening of the valve cover. The jam structure includes a first plate, a second plate, a rod between the first plate and the second plate, and one or more extensions extending relative to the second plate. Another safety device includes one or more locking plates configured to prevent opening of the fluid end when under pressure.

### BACKGROUND

### Field

The present disclosure relates to safety devices, locking assemblies, fluid ends, and related methods for pumping operations.

### Description of the Related Art

Covers, such as valve covers, may be used on fluid ends of frac pumps or mud pumps to seal and protect the internal components of the fluid ends. These covers are subjected to extremely high pressure fluid flow during operation of the fluid ends, and along with the other internal components of the fluid ends require periodic maintenance and/or repair. Unfortunately, workers conducting maintenance and/or repair have removed these covers unknowingly while the fluid end is still under pressure, resulting in injury to the workers.

Therefore, there is a need for safety devices for fluid ends.

### SUMMARY

Implementations of the present disclosure relate to safety devices, locking assemblies, fluid ends, and related methods for pumping operations.

In one or more embodiments, a safety device for fluid ends includes a valve cover including an outer shoulder and a receptacle opening, and a jam structure movable in the receptacle opening of the valve cover. The jam structure includes a first plate, a second plate, a rod between the first plate and the second plate, and one or more extensions extending relative to the second plate.

In one or more embodiments, a safety device for fluid ends includes a locking assembly. The locking assembly includes an actuator including one or more tapered surfaces and an actuator opening, and a plurality of wedges disposed about the actuator and movable between an unlocked position and a locked position. The safety device includes a jam structure. The jam structure includes a first segment, a second segment configured to abut against the first segment, and one or more biasing elements configured to bias the first segment and second segment toward each other.

In one or more embodiments, a fluid end for pumping operations includes a body including a plurality of bores formed therein and intersecting at a junction. The fluid end includes an inlet valve disposed in at least one of the bores, an outlet valve disposed in at least one of the bores, a valve cover coupled to the body and covering the outlet valve, and a locking assembly locking the valve cover to the body. The fluid end includes a jam structure disposed at least partially between the valve cover and the locking assembly. The jam structure is configured to restrict retraction of the locking assembly when a fluid flows through the outlet valve.

In one or more embodiments, a fluid end assembly for pumping operations includes a locking assembly and a safety device. The locking assembly includes an actuator and a lock ring disposed about the actuator. The safety device includes a locking plate configurable in a locked position and an unlocked position, where the locked position prevents upward movement of the actuator. The safety device further includes a coupling that couples the locking plate to the lock ring and permits the locking plate to move from the locked position to the unlocked position.

### BRIEF DESCRIPTION OF THE DRAWINGS

So that the manner in which the above-recited features of the disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a schematic isometric partial view of a fluid end having a fluid end body and a locking assembly in a locked position, according to one or more embodiments.

FIG. 2 is a schematic cross-sectional view of the fluid end illustrated in FIG. 1 along lines 2-2, according to one or more embodiments.

FIG. 3 is a schematic enlarged cross-sectional view of the locking assembly and the safety device shown in FIG. 2, according to one or more embodiments.

FIG. 4 is a schematic cross-sectional view of the locking assembly and the safety device shown in FIG. 3, according to one or more embodiments.

FIG. 5 is a schematic cross-sectional view of the locking assembly and the safety device shown in FIG. 3, according to one or more embodiments.

FIG. 6 is a schematic top cross-sectional view of the locking assembly and the jam structure along Section 6-6 shown in FIG. 5, according to one or more embodiments.

FIG. 7 is a schematic partial bottom perspective view of the locking assembly shown in FIGS. 2-5, according to one or more embodiments.

FIG. 8 is a schematic top perspective view of the valve cover shown in FIGS. 3-5, according to one or more embodiments.

FIG. 9 is a schematic top perspective view of the valve cover along Section 9-9 shown in FIG. 8, according to one or more embodiments.

FIG. 10 is a schematic enlarged cross-sectional view of the locking assembly and a safety device, according to one or more embodiments.

FIG. 11 is a schematic enlarged cross-sectional view of the locking assembly and the safety device shown in FIG. 10, according to one or more embodiments.

FIG. 12 is a schematic perspective view of the jam structure in the retracted position as shown in FIG. 10, according to one or more embodiments.

FIG. 13 is a schematic perspective view of the jam structure in the expanded position as shown in FIG. 11, according to one or more embodiments.

FIG. 14 is a schematic perspective top view of the jam structure shown in FIGS. 2-6, according to one or more embodiments.

FIG. 15 is a schematic top view of a safety device coupled to the locking assembly, the safety device being in a locked position, according to one or more embodiments.

FIG. 16 is a schematic top view of the safety device shown in FIG. 15 in an unlocked position, according to one or more embodiments.

FIG. 17A is a schematic perspective view of the safety device shown in FIG. 15 in the locked position, according to one or more embodiments.

FIG. 17B is a cross sectional view of the safety device shown in FIG. 15 in the locked position, according to one or more embodiments.

FIG. 18 is a schematic top view of a safety device coupled to the locking assembly, the safety device being in an unlocked position, according to one or more embodiments.

FIG. 19 is a schematic top view of the safety device shown in FIG. 18 in a locked position, according to one or more embodiments.

FIG. 20 is a schematic perspective view of the safety device shown in FIG. 18 in the locked position, according to one or more embodiments.

FIG. 21 is a schematic top view of a safety device coupled to the locking assembly, the safety device being in a locked position, according to one or more embodiments.

FIG. 22 is a schematic perspective view of the safety device shown in FIG. 21 in the locked position, according to one or more embodiments.

To facilitate understanding, identical reference numerals have been used, where possible, to designate identical elements that are common to the figures. It is contemplated that elements disclosed in one implementation may be beneficially utilized on other implementations without specific recitation.

### DETAILED DESCRIPTION

Implementations of the present disclosure relate to locking assembly apparatus and methods for fluid ends, and associated components thereof. In one or more embodiments, a locking assembly is used to lock a cover to a fluid end to cover a valve in the fluid end, and a jam structure is used to retain the locking assembly in a locked position while an outlet of the fluid end is pressurized. In one or more embodiments, a safety device comprising one or more locking plates is used to prevent opening of the fluid end, such as removal of a valve cover, when the fluid end contains pressurized fluid.

The disclosure contemplates that terms such as “couples,” “coupling,” “couple,” and “coupled” may include but are not limited to welding, fusing, melting together, interference fitting, and/or fastening such as by using bolts, threaded connections, pins, and/or screws. The disclosure contemplates that terms such as “couples,” “coupling,” “couple,” and “coupled” may include but are not limited to integrally forming. The disclosure contemplates that terms such as “couples,” “coupling,” “couple,” and “coupled” may include but are not limited to direct coupling and/or indirect coupling, such as indirect coupling through components such as links, blocks, and/or frames.

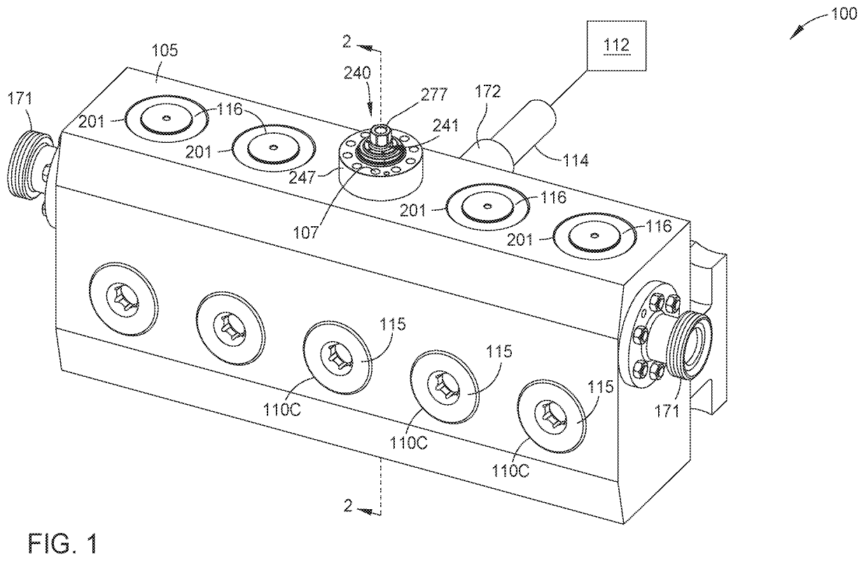

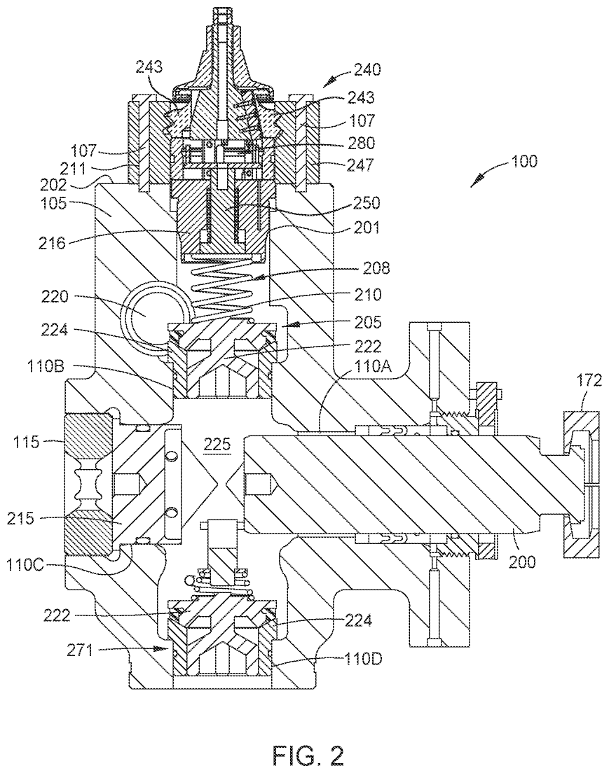

FIG. 1 is a schematic isometric partial view of a fluid end 100 having a fluid end body 105 and a locking assembly 240 in a locked position, according to one or more embodiments. The fluid end 100 includes a plurality of bores 110A-110D (bores 110A, bores 110B, and bores 110D are shown in FIG. 2) formed in the side of the fluid end body 105. The fluid end 100 illustrated includes a plurality of retainer nuts 115 disposed in each of the bores 110C. The fluid end 100 is adapted to couple to a power end 112 via a pony rod 114. While one pony rod 114 is shown, the power end 112 may have a pony rod that couples to each of the bores 110A (shown in FIG. 2) of the fluid end 100. A plunger clamp 172 or any other rod connector mechanism may be disposed between the fluid end 100 and the pony rod 114. A discharge flange 171 may be coupled to opposing ends of the fluid end body 105 for connecting hoses with a discharge manifold. A locking assembly 240 is disposed above one of the valve covers 116. The present disclosure contemplates that a locking assembly 240 may be disposed above each one of the valve covers 116 (five are illustrated). Although the locking assembly 240 is described herein as being used with a frac pump, the locking assembly 240 can be used with any other types of pumps, including but not limited to mud pumps, positive displacement pumps, etc.

The fluid end 100 includes a plurality of valve covers 116. Each valve cover 116 is disposed at least partially in an opening 201 formed in the top of the fluid end body 105. The openings 201 are at least part of the bores 110B. Four valve covers 116 are shown exposed along the top of the fluid end body 105. The center valve cover 116 is secured to the fluid end body 105 by the locking assembly 240. Although the locking assembly 240 is described herein as securing valve covers 116, the locking assembly 240 may be used to secure a plug, a suction cover, a discharge cover, an access cover, a strainer cover, a retainer nut, and/or any other type of component that needs to be secured to the fluid end body 105. The fluid end 100 illustrated includes a retainer nut 115 disposed in each of the bores 110B and a valve cover 116 disposed in each opening 201.

FIG. 2 is a schematic cross-sectional view of the fluid end 100 illustrated in FIG. 1 along lines 2-2, according to one or more embodiments. Bores 110A, 110B, 110C, and 110D are shown FIG. 2. A plunger 200 is shown disposed in the bore 110A, and a valve assembly 205 (an outlet valve) having a spring 210 is shown disposed in the bore 110B. A suction cover 215 is shown disposed in the bore 110C, and a suction valve assembly 271 (an inlet valve) is shown in the bore 110D. The suction cover 215 is disposed inwards of the retainer nut 115 relative to the fluid end body 105. A valve cover 216 is disposed in place of each valve cover 116 shown in FIG. 1. The valve cover 216 is coupled to (e.g., threaded into) the fluid end body 105 and covers the valve assembly 205. The valve cover 216 is a discharge cover. The valve assembly 205 and the suction valve assembly 271 a valve body 222 and a valve seat 224 disposed in the bores 110B and 110D.

The fluid end body 105 may also include a discharge manifold 220 formed therein that is in selective communication with at least the bore 110B. The bores 110A-110D formed in the fluid end body 105 intersect within the fluid end body 105 at a junction 225. The present disclosure contemplates that each of the suction covers 215 may be replaced with a cover similar to the valve cover 216, and/or the retainer nuts 115 may be replaced with a locking assembly similar to the locking assembly 240.

As shown in FIG. 2, the locking assembly 240 is coupled to the fluid end body 105 by a plurality of bolts 107 that are disposed through a plurality of openings 211 formed in a lock ring 247 and threaded into the fluid end body 105. When in the locked position, the locking assembly 240 locks the valve cover 216 fluid end body 105. A bolt 107 is disposed through each opening 211 to fasten the lock ring 247 to the fluid end body 105 and mount the lock ring 247 to an exterior surface 202 of the fluid end body 105. The lock ring 247 is disposed about a plurality of wedges 243. In one or more embodiments, the lock ring 247 is a flange.

An internal volume 208 is between the valve body 222 and the valve cover 216. A jam structure 250 is disposed at least partially between the valve cover 216 and the locking assembly 240. The jam structure 250 is configured to restrict retraction of the locking assembly 240 an unlocked position when a fluid flows through the valve assembly 205 (the outlet valve). When the fluid (such as a pump fluid, for example a frac fluid) is in the internal volume 208 at a pressure that is at or exceeds a threshold, the pressure exerts a force on the jam structure 250 that is sufficient to move the jam structure 250 in a first direction (e.g., upwardly) and between the wedges 243. The jam structure 250 and the valve cover 316 are part of a safety device 280. When the jam structure 250 is in the upper position shown (in FIG. 2) and between the wedges 243, the jam structure 250 restricts inward movement of the wedges 243 to restrict unlocking of the locking assembly 240 and facilitate retaining of the locking assembly 240 in the locked position (shown in FIG. 2) when the internal volume 208 is pressurized at or above the threshold.

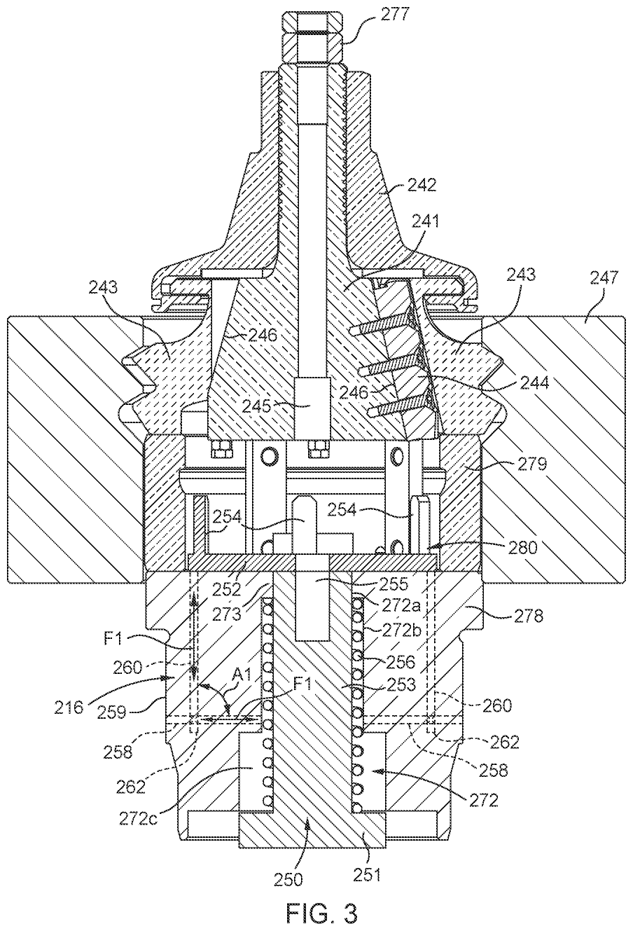

FIG. 3 is a schematic enlarged cross-sectional view of the locking assembly 240 and the safety device 280 shown in FIG. 2, according to one or more embodiments. In FIG. 3, the locking assembly 240 is shown in the locked position.

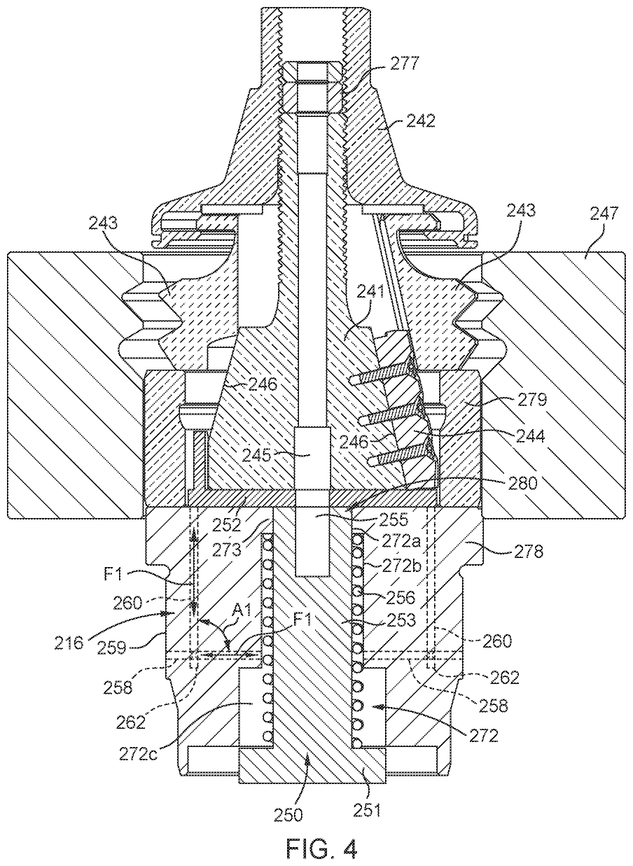

FIG. 4 is a schematic cross-sectional view of the locking assembly 240 and the safety device 280 shown in FIG. 3, according to one or more embodiments. In FIG. 4, the locking assembly 240 is shown in the unlocked position. In the unlocked position, the locking assembly 240 including the first actuator 241, the second actuator 242, and the wedges 243 can be pulled upward and out of the lock ring 247 when access to the valve cover 216 and or any components below the locking assembly 240 is required. Similarly, the locking assembly 240 in in the unlocked position when installing the first actuator 241, the second actuator 242, and the wedges 243 into the lock ring 247.

The valve cover 216 includes an outer shoulder 278 and a receptacle opening 272. The jam structure 250 is movable in the receptacle opening 272 of the valve cover 216. The jam structure 250 includes a first plate 251, a second plate 252, a rod 253 between the first plate 251 and the second plate 252, and one or more extensions 254 (a plurality of extensions is shown) extending relative to the second plate 252. The rod 253 extends relative to a first side of the second plate 252, and the one or more extensions 254 extend relative to a second side of the second plate 252. The jam structure 250 also includes a recess 255 extending into the second side of the second plate 252 and partially into the rod 253. In one or more embodiments, the first plate 251 and the second plate 252 are discal in shape, the rod 253 is cylindrical in shape, and the one or more extensions 254 each have a rectangular cross section.

The valve cover 216 also includes an inner shoulder 273 opposing the outer shoulder 278. The safety device 280 also includes a biasing element 256 positioned between the inner shoulder 273 of the valve cover 216 and the first plate 251 of the jam structure 250. The biasing element 256 is shown as a spring. The present disclosure contemplates that other biasing elements (such as fluid paths) may be used. In one or more embodiments, the biasing element 256 is a coil spring, such as a helical compression spring. The present disclosure contemplates that other springs, such as wave springs, constant force springs, flat springs, leaf springs, gas springs, garter springs, and/or torsion springs, may be used for the biasing element 256.

The receptacle opening 272 of the valve cover 216 includes a first section 272a, a second section 272b larger than the first section 272a, and a third section 272c larger than the second section 272b. The first section 272a extends into the second side of the second plate 252, and the first section 272a is sized and shaped to receive the rod 253 of the jam structure 250 therethrough. The first section 272a is smaller than the second plate 252. The third section 272c is sized and shaped to receive the first plate 251.

The valve cover 216 includes one or more first fluid openings 258 (two are shown) extending between the second section 272b of the receptacle opening 272 and an arcuate outer surface 259 of the valve cover 216. The valve cover 216 includes one or more second fluid openings 260 (two are shown) intersecting the one or more first fluid openings 258. The one or more second fluid openings 260 are oriented at an angle A1 relative to the one or more first fluid openings 258. In one or more embodiments, the angle A1 is about 90 degrees. The present disclosure contemplates that other values may be used for the angle A1. The present disclosure contemplates that the first fluid opening(s) 258 and/or the second fluid opening(s) 260 can be used to supply an actuation fluid to a volume 261 behind the second plate 252 and/or the receptacle opening 272 (such as the second section 272b and/or the third section 272c above the first plate 251). The actuation fluid can be, for example, a fluid (such as a hydraulic fluid and/or a pneumatic fluid) supplied from a source outside of the fluid end body 105. The actuation fluid can be, for example, a part of the pump fluid (e.g., the frac fluid) pumped through the internal volume 208. The actuation fluid can be used in place of or in addition to the biasing element 256 shown. The actuation fluid can be used to override movement (e.g., the upward movement) of the jam structure 250 that is caused by the pump fluid in the internal volume 208, the override causing the jam structure 250 to move (e.g., downwardly). The actuation fluid can be used as the biasing element (e.g., as a gas spring), such that movement (e.g., upward movement) of the jam structure 250 stores potential energy in actuation fluid. When the pressure of the pump fluid in the internal volume 208 falls below the threshold, the potential energy in the actuation fluid biases the jam structure 250 (e.g., biases downwardly). In one or more embodiments, one or more switching valves 262 (two are shown) are positioned in the valve cover 216. The or more switching valves 262 are configured to at least partially switch flow of the actuation fluid between the one or more first fluid openings 258 and the one or more second fluid openings 260.

The locking assembly 240 includes a first actuator 241 disposed at least partially within a second actuator 242, and the plurality of wedges 243 are disposed about the first actuator 241. The first actuator 241 has an inner bore 245 and an upper head 277 to provide a visual indication that the locking assembly is in the locked position. The first actuator 241 includes one or more tapered surfaces 246 (a plurality of tapered surfaces are shown). The wedges 243 are coupled to the first actuator 241 through blocks 244 that are disposed in slots formed in tapered inner surfaces of the wedges 243. The blocks 244 are coupled (e.g., fastened) to the first actuator 241. The wedges 243 are moved between the locked position and the unlocked position.

With reference to FIGS. 3 and 4, the first actuator 241 is in threaded engagement with the second actuator 242. The second actuator 244 can be turned in a first rotational direction and a second rotational direction that is opposite of the first rotational direction. Turning the second actuator 242 in the first rotational direction drives the first actuator 241 in the first direction (e.g., upwards) by the threaded engagement between the outer surface of the first actuator 241 and the inner surface of the second actuator 242, thereby pushing the wedges 243 outwardly to the locked position. Turning the second actuator 242 in the second rotational direction drives the first actuator 241 in a second direction (e.g., downwards) by the threaded engagement between the outer surface of the first actuator 241 and the inner surface of the second actuator 242, thereby pulling (e.g., using the blocks 244) the wedges 243 inwardly to the unlocked position where teeth of the wedges 243 are disengaged from teeth of the locking ring 247. Positioned below the wedges 243 is a load ring 279 of the safety device 280, which abuts against the valve cover 216.

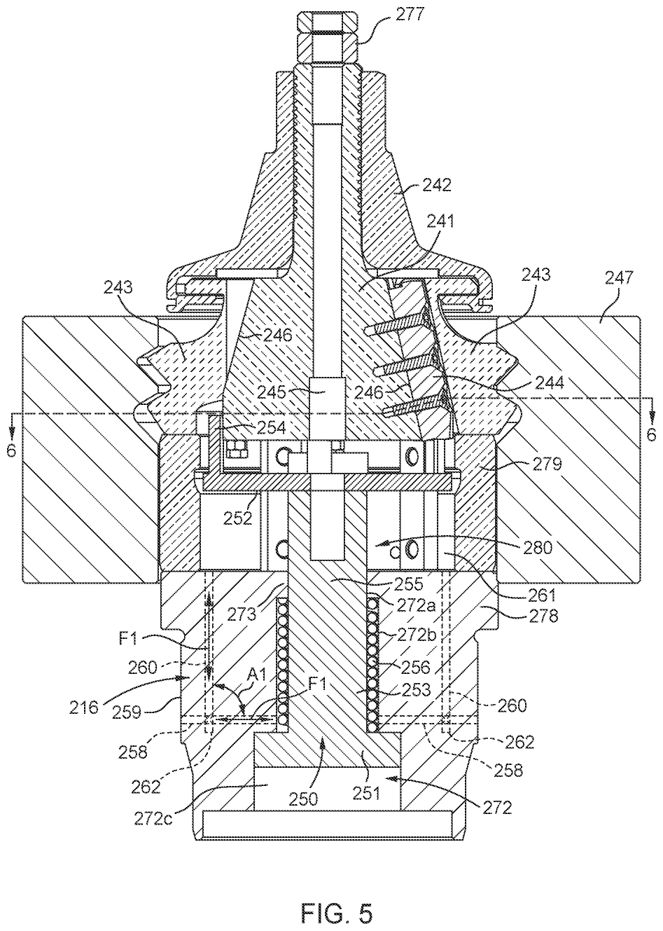

FIG. 5 is a schematic cross-sectional view of the locking assembly 240 and the safety device 280 shown in FIG. 3, according to one or more embodiments. In FIG. 5, the jam structure 250 is shown in the upper position to restrict moving of the wedges 243 inwardly to retain the locking assembly 240 in the locked position.

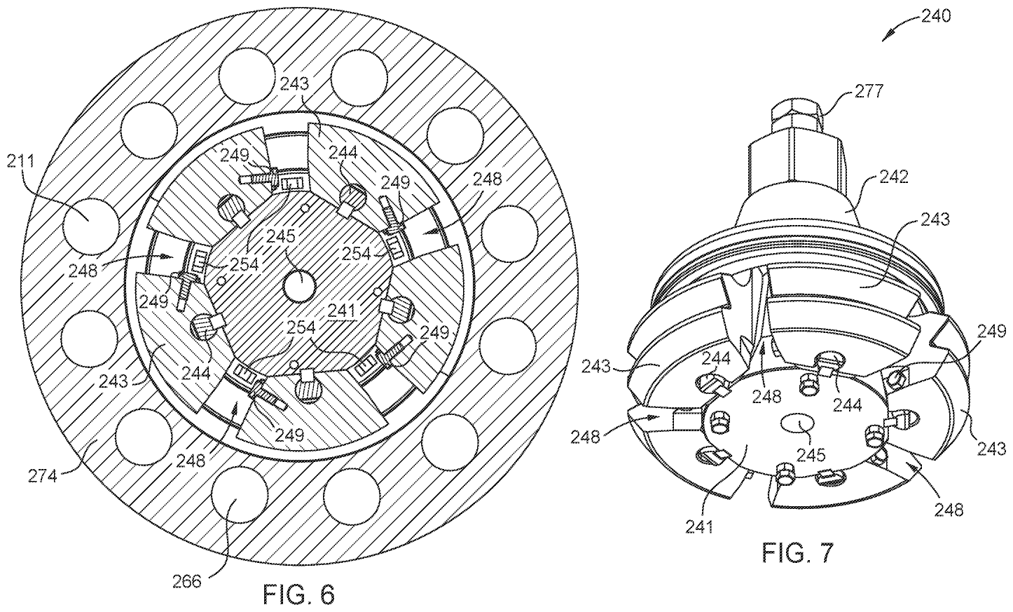

FIG. 6 is a schematic top cross-sectional view of the locking assembly 240 and the jam structure 250 along Section 6-6 shown in FIG. 5, according to one or more embodiments.

In the upper position of the jam structure 250, the one or more extensions 254 extending into one or more openings 248 (a plurality is shown) disposed between the wedges 243. In one or more embodiments, one or more protrusions 249 (such as heads of screw(s) or bolt(s)) are coupled to the wedges 243 to abut against the one or more extensions 254 and restrict inward movement of the wedges 243 when the jam structure 250 is in the upper position. The one or more extensions 254 include a plurality of extensions 254 that are spaced equidistantly from each other along a circumferential pattern (such as a circumferential patter along the second plate 252).

FIG. 7 is a schematic partial bottom perspective view of the locking assembly 240 shown in FIGS. 2-5, according to one or more embodiments.

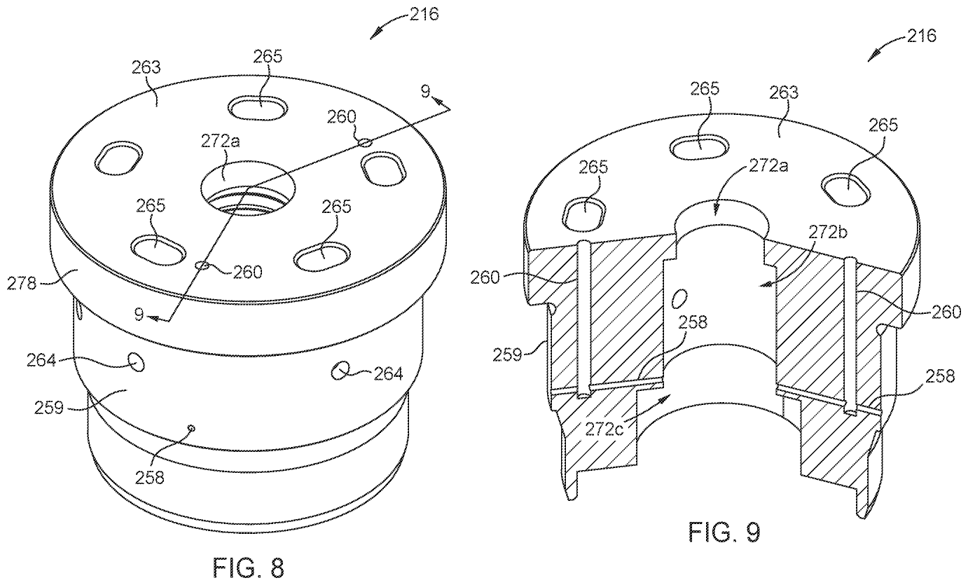

FIG. 8 is a schematic top perspective view of the valve cover 216 shown in FIGS. 3-5, according to one or more embodiments.

The valve cover 216 includes a planar outer surface 263 and one or more fluid openings 264 (a plurality is shown) extending into the arcuate outer surface 259 and to the planar outer surface 263. Section(s) of the one or more fluid openings 264 include one or more alignment openings 265 (a plurality is shown) extending into the planar outer surface 263.

FIG. 9 is a schematic top perspective view of the valve cover 216 along Section 9-9 shown in FIG. 8, according to one or more embodiments.

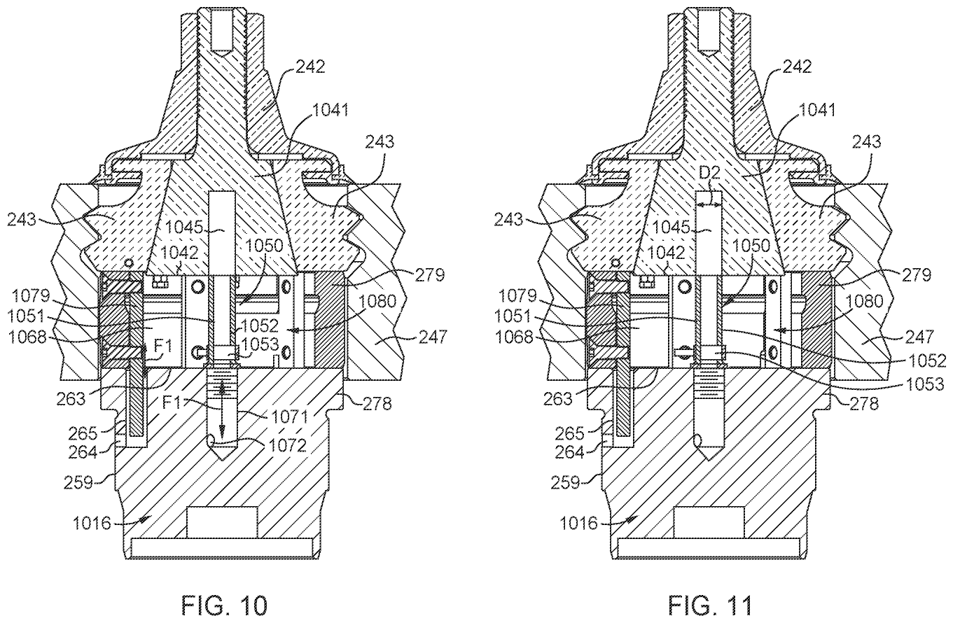

FIG. 10 is a schematic enlarged cross-sectional view of the locking assembly 240 and a safety device 1080, according to one or more embodiments.

The safety device 1080 includes a valve cover 1016 that includes one or more features of the valve cover 216, and a first actuator 1041 that includes one or more features of the first actuator 241. The safety device 1080 includes a jam structure 1050. The jam structure 1050 includes a first segment 1051, a second segment 1052 configured to abut against the first segment 1051, and a biasing element 1053 configured to bias the first segment 1051 and second segment 1052 toward each other. The biasing element 1053 includes a torsion spring disposed about the first and second segments 1051, 1052. The present disclosure contemplates that other springs, such as coil springs, helical compression springs, wave springs, constant force springs, flat springs, leaf springs, gas springs, garter springs, and/or torsion springs, may be used for the biasing element 1053. The present disclosure contemplates that other biasing elements (such as fluid paths) may be used.

In FIG. 10, the jam structure 1050 is shown in a retracted position where the first and second segments 1051, 1052 abut against each other. The first actuator 1041 includes a bottom surface 1042 and an actuator opening 1045 (e.g., a recess) formed in the bottom surface 1042. When the jam structure 1050 is in the retracted position the first and second segments 1051, 1052 fit into the actuator opening 1045 such that the first actuator 1041 can move in the second direction (e.g., downwardly) over the first and second segments 1051, 1052 to unlock the locking assembly 240.

The load ring 279 is aligned relative to the valve cover 1016 using one or more alignment extensions 1079 (a plurality is shown) extending into the one or more alignment openings 265. The one or more alignment extensions 1079 are coupled (e.g., fastened) to the load ring 279.

FIG. 11 is a schematic enlarged cross-sectional view of the locking assembly 240 and the safety device 1080 shown in FIG. 10, according to one or more embodiments. In FIG. 11, the jam structure 1050 is shown in an expanded position where the first and second segments 1051, 1052 are spaced from each other.

When the jam structure 1050 is in the expanded position the first and second segments 1051, 1052 abut against the bottom surface 1042 to restrict movement in the second direction (e.g., downwardly) of the first actuator 1041 to retain the locking assembly 240 in the locked position.

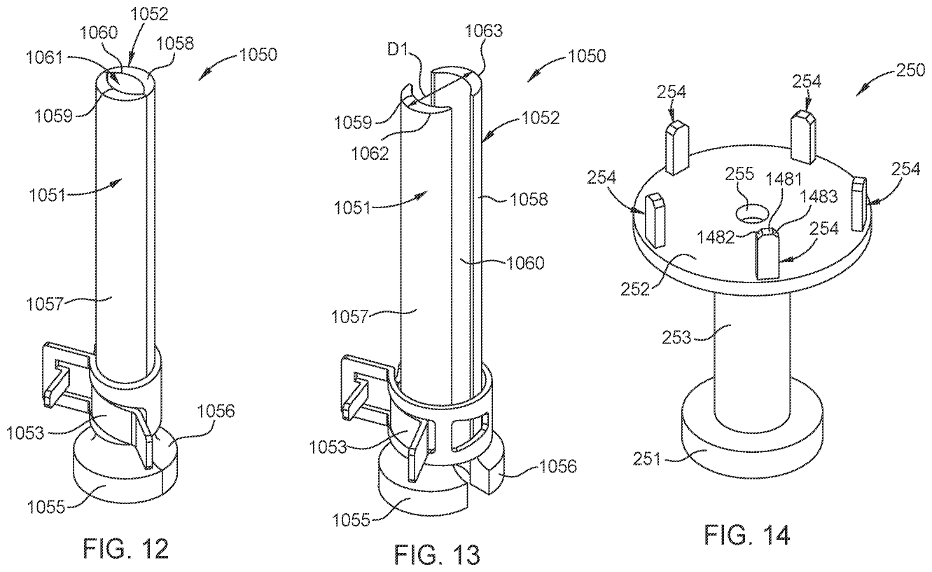

FIG. 12 is a schematic perspective view of the jam structure 1050 in the retracted position as shown in FIG. 10, according to one or more embodiments.

The first segment 1051 and the second segment 1052 each include a shoulder section 1055, 1056, an elongated section 1057, 1058 extending relative to the shoulder section 1055, 1056, and an inner recess 1059, 1060 extending along the elongated section 1057, 1058 and the shoulder section 1055, 1056. The inner recesses 1059, 1060 of the first and second segments 1051, 1052 define a central opening 1061 when the second segment 1052 abuts against the first segment 1051. In one or more embodiments, the central opening 1061 is ovular in shape. Other shapes are contemplated for the central opening 1061.

FIG. 13 is a schematic perspective view of the jam structure 1050 in the expanded position as shown in FIG. 11, according to one or more embodiments.

A distance D1 between outer edges 1062, 1063 of the elongated sections 1057, 1058 is smaller than a diameter D2 (shown in FIG. 11) of the actuator opening 1045 when the second segment 1052 abuts against the first segment 1051.

As shown in FIGS. 11 and 12, the shoulder sections 1055, 1056 of the first and second segments 1051, 1052 are configured to abut against and slide along the planar outer surface 263 of the valve cover 1016. The one or more fluid openings 264 of the valve cover 1016 supply an actuation fluid (such as a fluid from a source outside of the fluid end body 105 and/or a pump fluid (e.g., frac fluid)) to a volume 1068 between the valve cover 1016 and the first actuator 1041. The actuation fluid flows through the volume 1068 and into the central opening 1061 from above the jam structure 1050. In addition to or in place of the one or more fluid openings 264, the actuation fluid can flow into a recess 1071 of the valve cover 1016 through one or more fluid openings 1072 extending between the recess 1071 and the arcuate outer surface 259. The actuation fluid supplied from the one or more fluid openings 1072 can flow into the central opening 1061 from below the jam structure 1050 (e.g., from the recess 1071). The actuation fluid in the jam structure 1050 pressurizes the inner recesses 1059, 1060 to actuate the first and second segments 1051, 1052 outwardly and into the expanded position.

FIG. 14 is a schematic perspective top view of the jam structure 250 shown in FIGS. 2-6, according to one or more embodiments. In one or more embodiments, each extension 254 (five are shown in FIG. 14) includes a rectangular column and an end face that includes a pair of angled sections 1482, 1483 intersecting a planar section 1481 on opposing sides of the planar section 1481.

As discussed herein, the moving of the jam structure 250 to the upper position restricts the wedges 243 from moving toward each other, which restricts moving in the second direction (e.g., downwardly) of the wedges 243 to restrict unlocking of the locking assembly 240 when the internal volume 208 is pressurized for worker safety. As discussed herein, the moving of the jam structure 1050 to the expanded position blocks the first actuator 1041 to restrict movement in the second direction (e.g., downwardly) of the first actuator 1041, which restricts unlocking of the locking assembly 240 when the internal volume 208 is pressurized for worker safety.

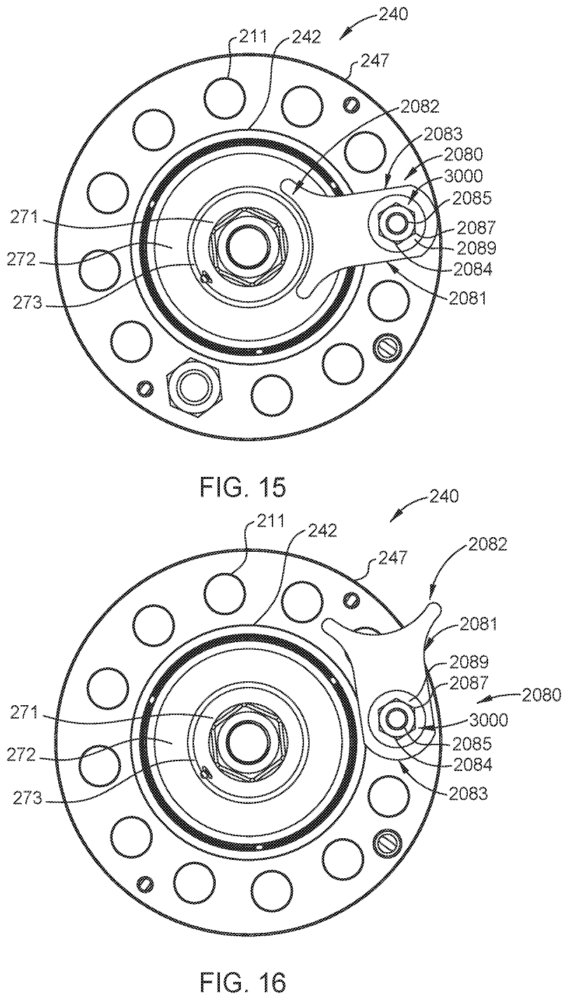

FIGS. 15-17B are schematic views of a safety device 2080 coupled to the locking assembly 240, according to one or more embodiments.

The safety device 2080 is used to prevent upward movement of the second actuator 242 (such as to remove the locking assembly 240) when the safety device 2080 is in a locked position similarly to safety devices 280 and 1080. The safety device 2080 comprises a locking plate 2081. The locking plate 2081 is coupled to the lock ring 247 of the locking assembly 240. The locking plate 2081 may be coupled to the lock ring 247 by using a swivel coupling 3000 that allows the locking plate 2081 to swivel (such as rotate) with respect to the locking assembly 240. The swivel coupling 3000 may be any type of coupling that permits swiveling, but in the illustrated embodiment, the locking plate 2081 is coupled to the lock ring 247 utilizing a threaded rod 2085, a first nut 2086, a washer 2089 (which may be optional), and a second nut 2087, which form the swivel coupling 3000.

The threaded rod 2085 is disposed in one of the plurality of openings 211, and the first nut 2086 is threaded onto the threaded rod 2085 and contacts the lock ring 247. The locking plate 2081 comprises a hole 2084 that is placed over the threaded rod 2085. The locking plate 2081 sits on a shoulder 2090 of the threaded rod 2085. The washer 2089 is placed over the threaded rod 2085 and contacts the locking plate 2081. The second nut 2087 is threaded onto the threaded rod 2085 above the washer 2089 such that the locking plate 2081 is disposed between the shoulder 2090 and the washer 2089. In one embodiment, the locking plate 2081 can be disposed on the first nut 2086 rather than the shoulder 2090, and the second nut 2087 (with or without the washer 2089) can be threaded down on top of the locking plate 2081.

The locking plate 2081 has a first end 2083 and a second end 2082. The first end 2083 comprises the hole 2084 that allows for the lock ring 247 to be coupled to the swivel coupling 3000. The second end 2082 is shaped complementary to the second actuator 242 in a way that prevents the second actuator 242 from being moved (such as lifted) upwards with respect to the lock ring 247. The second actuator 242 is conical in shape with a step 273 where the angle of the conical shape increases. The step 273 creates a first conical section 271 and a second conical section 272. The first conical section 271 has a smaller conical angle relative to the second conical section 272, and the second conical section 272 has a larger conical angle relative to the first conical section 271.

The second end 2082 of the locking plate 2081 is at least partially semi-circular in shape to receive at least a part of the diameter of the first conical section 271, blocking upward movement of the second conical section 272, and therefore the second actuator 242, with respect to the lock ring 247 when the locking plate 2081 is in the locked position. While the second actuator 242 is shown with a conical shape and the second end 2082 of the locking plate 2081 with a semi-circular shape, the second actuator 242 and the second end 2082 of the locking plate 2081 may be shaped differently so long as the second end 2082 is complementary to the shape of the second actuator 242 to cover the second actuator 242 and prevent upward movement of the second actuator 242 with respect to the lock ring 247 when the locking plate 2081 is in the locked position.

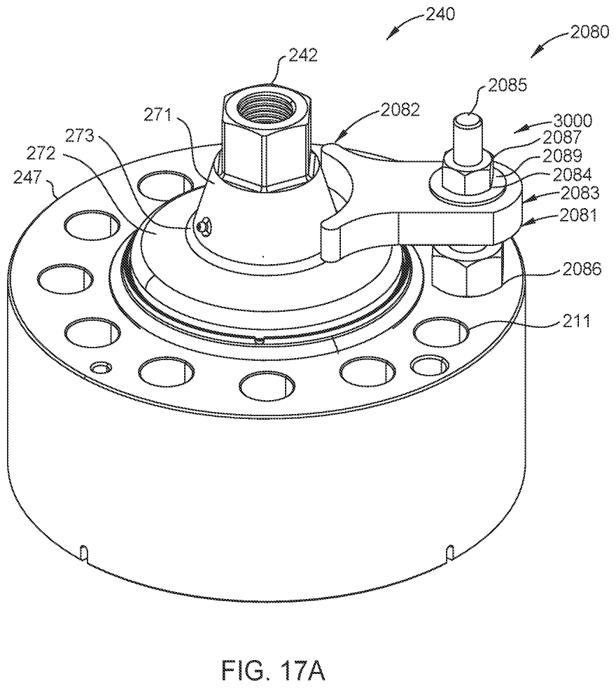

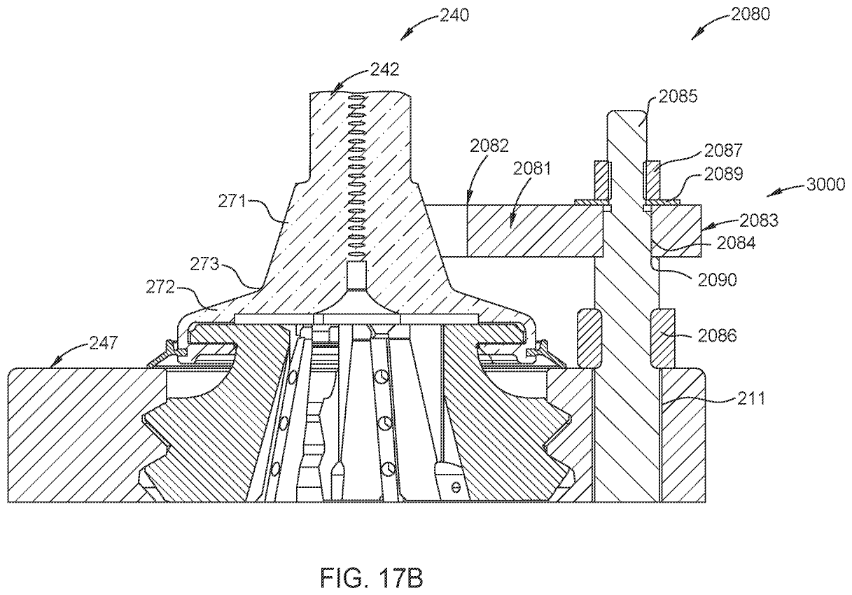

FIGS. 15 and 17 are schematic views of the locking assembly 240 and the safety device 2080 in the locked position. To move from the unlocked position to the locked position, the locking plate 2081 is rotated about the swivel coupling 3000 to move the second end 2082 to be positioned inward toward the second actuator 242 to prevent the second actuator 242 from moving upward with respect to the lock ring 247 by covering at least a portion of the second actuator 242 with the second end 2082 of the locking plate 2081. Once the locking plate 2081 is positioned to block upward movement of the second actuator 242, the swivel coupling 3000 may be configured to prevent the locking plate 2081 from rotating by tightening the second nut 2087 to securely clamp the locking plate 2081 between the washer 2089 and the shoulder 2090.

FIG. 16 is a schematic top view of the locking assembly 240 and the safety device 2080 in the unlocked position. To move from the locked position to the unlocked position, the locking plate 2081 is rotated about the swivel coupling 3000 and away from the second actuator 242 to permit the second actuator 242 to move upward with respect to the lock ring 247. The locking plate 2081 rotated into the unlocked position to unblock (such as uncover) the second actuator 242 and permit the upward movement of the second actuator 242. To permit rotation of the locking plate 2081 about the swivel coupling 3000, the second nut 2087 may need to be loosened. The locking plate 2081 may be rotated about the swivel coupling 3000 within a range of 0-360 degrees when unobstructed. The locking plate 2081 may be rotated to any position above the second actuator 242 sufficient to prevent the second actuator 242 from being removed from the lock ring 247.

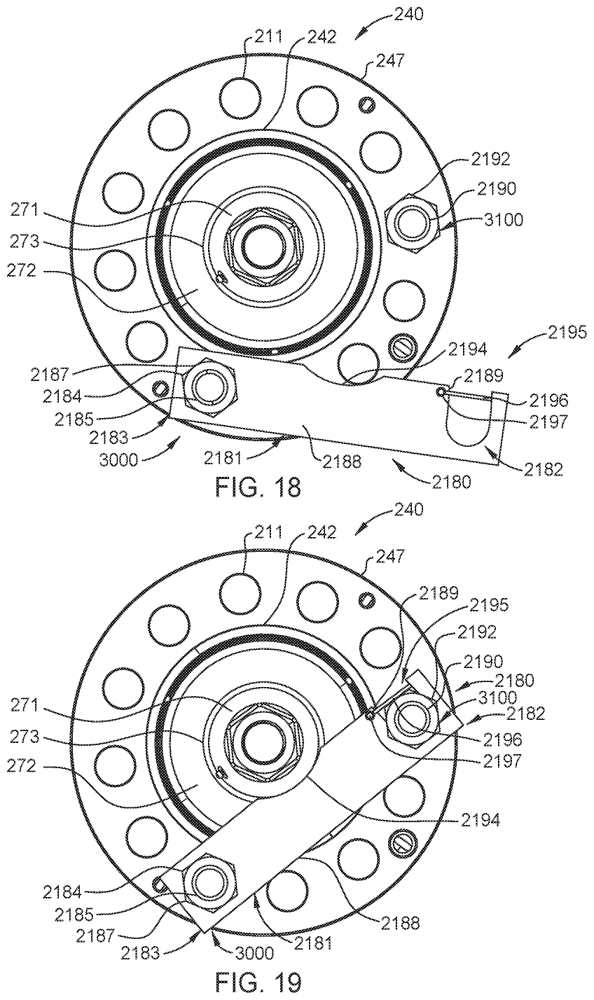

FIGS. 18-20 are schematic views of a safety device 2180 coupled to the locking assembly 240, according to one or more embodiments.

The safety device 2180 is used to prevent upward movement of the second actuator 242 (such as to remove the locking assembly 240) when the safety device 2180 is in a locked position similarly to safety devices 280, 1080, and 2080. The safety device 2180 comprises a slotted locking plate 2181. The slotted locking plate 2181 is coupled to the lock ring 247 of the locking assembly 240 using a swivel coupling 3000 similarly to the locking plate 2081 of safety device 2080. The swivel coupling 3000 allows the slotted locking plate 2181 to swivel (such as rotate) about that swivel coupling 3000. The swivel coupling 3000 comprises the threaded rod 2185, the first nut 2186, and the second nut 2187 as explained above. The slotted locking plate 2181 comprises a hole 2184 at a first end 2183 of the slotted locking plate 2181 through which the threaded rod 2185 is disposed to complete the swivel coupling 3000.

The slotted locking plate 2181 further comprises a slot 2189 disposed at a second end 2182 of the slotted locking plate 2181. The safety device 2180 further comprises a fixed coupling 3100 that secures the second end 2182 of the slotted locking plate 2181. The fixed coupling 3100 comprises a second threaded rod 2190, a third nut 2191, and a fourth nut 2192. The slot 2189 is configured to receive and/or engage the second threaded rod 2190. The second threaded rod 2190 is disposed in a different opening of the plurality of openings 211 (relative to the swivel coupling 3000). The third nut 2191 is threaded onto the second threaded rod 2190 and into contact with the lock ring 247. The slotted locking plate 2181 is rotated in a first direction about the swivel coupling 3000 until the second threaded rod 2190 is disposed in the slot 2189, which prevents further rotation of the slotted locking plate 2181 in the first direction. The fourth nut 2192 is threaded onto the second threaded rod 2190 and into contact with a top surface of the slotted locking plate 2181.

The slotted locking plate 2181 further comprises a body portion 2188 between the first end 2183 and the second end 2182. The body portion 2188 may be shaped in any way that prevents the second actuator 242 from moving upwards with respect to the lock ring 247 by covering at least a portion of the second actuator 242 with the body portion 2188. The body portion 2188 is shaped complementary to the second actuator 242. The second actuator 242 has a stepped conical shape as described above with reference to FIG. 15. Thus, the body portion 2188 comprises a semi-circular cutout 2194 to receive the step 273 of the second actuator 242. While the second actuator 242 is shown with a conical shape and the body portion 2188 is shown with a semicircular cutout 2194, the second actuator 242 and the body portion 2188 of the locking plate 2181 may be shaped differently so long as the body portion 2188 is complementary to the shape of the second actuator 242 and covers at least a portion of the second actuator 242 to prevent upward movement of the second actuator 242 with respect to the lock ring 247 when the slotted locking plate 2181 is in the locked position.

The slotted locking plate 2181 further comprises a latch 2195. The latch 2195 comprises a latch arm 2196 pivotably coupled to a pin member 2197. One end of the latch arm 2196 is coupled to the second end 2182 of the slotted locking plate 2181 by the pin member 2197 on one side of the slot 2189. The opposite end of the latch arm 2196 from the pin member 2197 may latch to the other side of slot 2189. When the opposite end of the latch arm 2196 is latched to the other side of the slot 2189, the latch arm 2196 coupes the slotted locking plate 2181 to the fixed coupling 3100.

The latch arm 2196 is pivotable with respect to the slotted locking plate 2181 by the pin member 2197. The latch arm 2196 may pivot outward from the slot 2189 or inward towards the slot 2189. The latch arm 2196 is pivotable between a latched and an unlatched configuration. In the unlatched configuration, the latch arm 2196 opens the slot 2189 and does not prevent the fixed coupling 3100 from entering the slot 2189. In the latched configuration, the latch arm 2196 completely encloses the slot 2189 and prevents the fixed coupling 3100 from entering or exiting the slot 2189. The latch arm 2196 may also be biased, such as by a spring member, into the latched configuration.

FIG. 18 is a schematic top view of the locking assembly 240 and the safety device 2180 in the unlocked position. In the unlocked position, the slotted locking plate 2181 is coupled to the lock ring 247 by the swivel coupling 3000 but not coupled by the fixed coupling 3100. This configuration permits the slotted locking plate 2181 to swivel about the swivel coupling 3000 away from the second actuator 242 to uncover the second actuator 242 to permit the second actuator 242 to be moved upward with respect to the lock ring 247. To permit swiveling about the swivel coupling 3000, the second nut 2187 may need to be loosened. The slotted locking plate 2181 may be rotated about the swivel coupling 3000 within a range of 0-360 degrees when unobstructed.

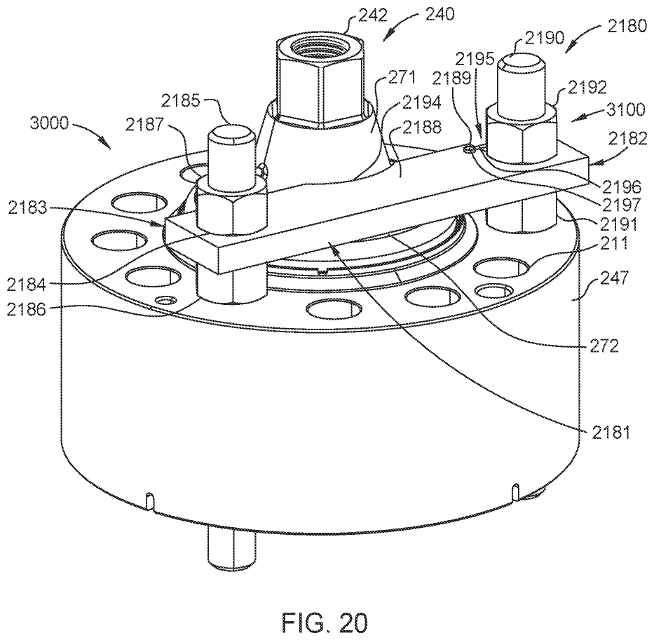

FIGS. 19 and 20 are schematic views of the locking assembly 240 and the safety device 2180 in the locked position. In the locked position, the slotted locking plate 2181 is swiveled about the swivel coupling 3000, the second end 2182 is engaged with the second threaded rod 2190 of the fixed coupling 3100, and the fourth nut 2192 is tightened to clamp the slotted locking plate 2181 in place between the third nut 2191 and the fourth nut 2192. In the locked position, the slotted locking plate 2181 prevents the second actuator 242 from moving upward with respect to the lock ring 247 by covering at least a portion of the second actuator 242.

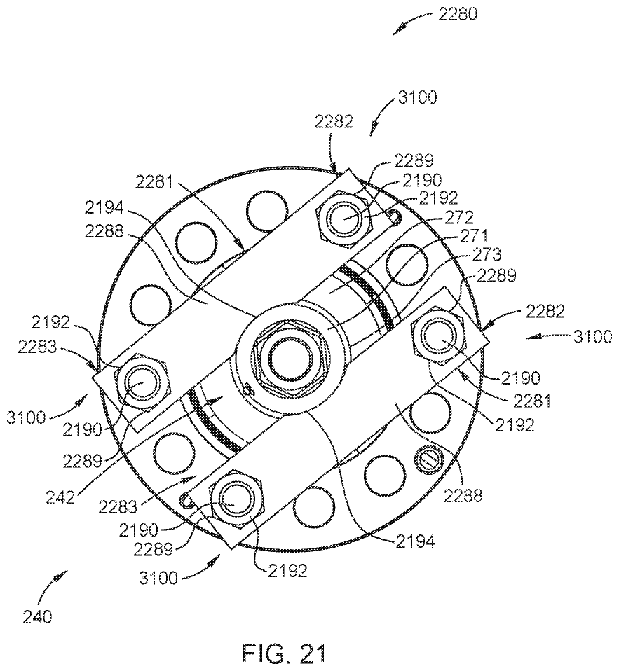

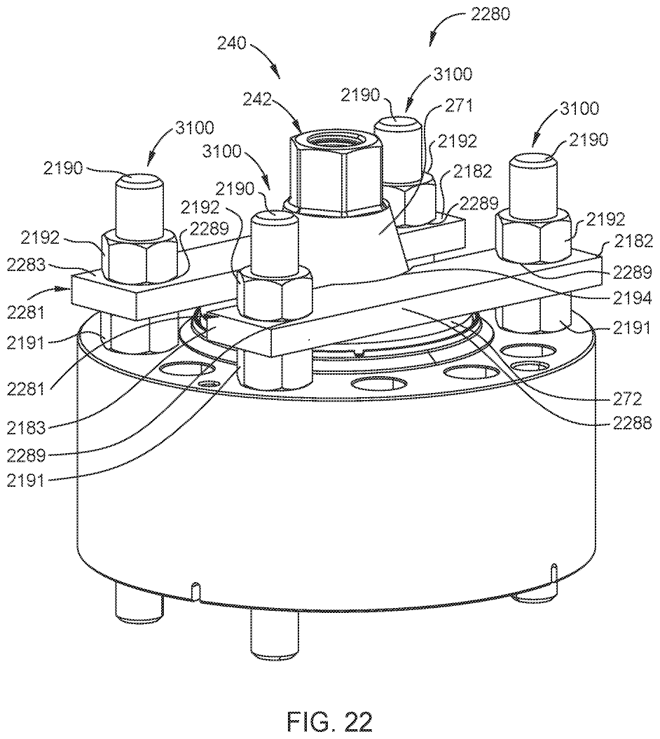

FIGS. 21-22 are schematic views of a safety device 2280 coupled to the locking assembly 240 in a locked position, according to one or more embodiments.

The safety device 2280 is used to prevent upward movement of the second actuator 242 (such as to remove the locking assembly 240) when the safety device is in the locked position similarly to safety devices 280 and 1080. The safety device 2280 comprises a pair of locking plates 2281, each of which are secured to the locking assembly by a pair of fixed couplings 3100 (similar to the fixed coupling 3100 of the safety device 2180).

Each of the locking plates 2281 comprise holes 2289 disposed at opposite ends 2282, 2283. The fixed couplings 3100 are spaced and coupled to the lock ring 247 such that the holes 2289 of the locking plates 2281 can be aligned with and positioned through the threaded rods 2190 and onto the third nuts 2191. The fourth nuts 2192 are tightened onto the threaded rods 2190 to clamp the respective ends of the locking plate 2281 in place between the third nuts 2191 and the fourth nuts 2192. Each of the locking plates 2281 comprise body portions 2288 having a semi-circular cutout 2194 to receive the step 273 of the second actuator 242. In the locked position, the body portions 2288 of the slotted locking plates 2281 cover at least a portion of the first actuator 242 to prevent upward movement of the second actuator 242 with respect to the lock ring 247.

As discussed herein, restricting unlocking and/or removal of the locking assembly 240 when the internal volume 208 is pressurized reduces or eliminates the chances of worker injury, and lock-up or movement of parts of the safety device and/or the locking assembly that might otherwise occur when the internal volume is pressurized.

Benefits of the present disclosure include reduced or eliminated unlocking of a locking assembly and/or a valve cover when a fluid end is under pressure to prevent worker injury; reduced or eliminated lock-up of fluid end components; reduced or eliminated movement of fluid end components; reduced or eliminated damage of fluid end components; and quick operational times (such as servicing, assembly, and/or disassembly) for fluid ends and locking assemblies.

Benefits of the present disclosure also include quick and safe access to inside the fluid ends for maintenance, replacement, and/or repair; reduced complexity for fluid end operation and/or design; reduced numbers of components for fluid ends; reduced costs; increased efficiencies; reduced operational and maintenance times for fluid ends; ease of manual operation; long operational lifespans for fluid ends; and high operating pressure capabilities (such as maintained seal engagements at high operating pressures) for fluid ends.

It is contemplated that one or more of these aspects disclosed herein may be combined. Moreover, it is contemplated that one or more of these aspects may include some or all of the aforementioned benefits.

As an example, the present disclosure contemplates that one or more of the aspects, features, components, operations, and/or properties of the 100, the locking assembly 240, the valve cover 216, the first actuator 241, the jam structure 250, the valve cover 1016, the first actuator 1041, the jam structure 1050, and the safety devices 2080, 2180, and 2280 may be combined.

It will be appreciated by those skilled in the art that the preceding embodiments are exemplary and not limiting. It is intended that all modifications, permutations, enhancements, equivalents, and improvements thereto that are apparent to those skilled in the art upon a reading of the specification and a study of the drawings are included within the scope of the disclosure. It is therefore intended that the following appended claims may include all such modifications, permutations, enhancements, equivalents, and improvements. The present disclosure also contemplates that one or more aspects of the embodiments described herein may be substituted in for one or more of the other aspects described. The scope of the disclosure is determined by the claims that follow.

We claim:

1. A safety device for fluid ends, comprising:
a valve cover comprising an outer shoulder and a receptacle opening; and
a jam structure movable in the receptacle opening of the valve cover, the jam structure comprising:
a first plate,
a second plate,
a rod between the first plate and the second plate, and
one or more extensions extending relative to the second plate.

2. The safety device of claim 1, wherein the first plate and the second plate are discal in shape, the rod is cylindrical in shape, and the one or more extensions each have a rectangular cross section.

3. The safety device of claim 1, wherein the valve cover further comprises an inner shoulder opposing the outer shoulder, and safety device further comprises:
a biasing element positioned between the inner shoulder of the valve cover and the first plate of the jam structure.

4. The safety device of claim 1, wherein the rod extends relative to a first side of the second plate, wherein the one or more extensions extend relative to a second side of the second plate, and wherein the one or more extensions include a plurality of extensions that are spaced equidistantly from each other along a circumferential pattern.

5. The safety device of claim 1, wherein the rod extends relative to a first side of the second plate, wherein the one or more extensions extend relative to a second side of the second plate, and wherein the jam structure further comprises a recess extending into the second side of the second plate and partially into the rod.

6. The safety device of claim 1, wherein the rod extends relative to a first side of the second plate, wherein the one or more extensions extend relative to a second side of the second plate, and wherein the receptacle opening of the valve cover comprises:
a first section extending into the second side of the second plate, the first section sized and shaped to receive the rod of the jam structure therethrough, and the first section smaller than the second plate;
a second section larger than the first section; and
a third section larger than the second section, the third section sized and shaped to receive the first plate.

7. The safety device of claim 6, wherein the valve cover further comprises:
one or more first fluid openings extending between the second section of the receptacle opening and an arcuate outer surface of the valve cover; and
one or more second fluid openings intersecting the one or more first fluid openings, the one or more second fluid openings oriented at an angle relative to the one or more first fluid openings, and
wherein the safety device further comprises:
one or more switching valves positioned in the valve cover, the one or more switching valves configured to at least partially switch flow of a fluid between the one or more first fluid openings and the one or more second fluid openings.

8. A safety device for fluid ends, comprising:
a locking assembly comprising:
an actuator comprising one or more tapered surfaces and an actuator opening, and
a plurality of wedges disposed about the actuator and movable between an unlocked position and a locked position; and
a jam structure comprising:
a first segment,
a second segment configured to abut against the first segment, and
a biasing element configured to bias the first segment and second segment toward each other.

9. The safety device of claim 8, wherein the biasing element comprises a torsion spring disposed about the first and second segments.

10. The safety device of claim 8, wherein the first segment and the second segment each comprise:
a shoulder section;
an elongated section extending relative to the shoulder section; and
an inner recess extending along the elongated section and the shoulder section.

11. The safety device of claim 10, wherein the inner recesses of the first and second segments define a central opening when the second segment abuts against the first segment.

12. The safety device of claim 10, wherein a distance between outer edges of the elongated sections is smaller than a diameter of the actuation opening when the second segment abuts against the first segment.

13. The safety device of claim 10, further comprising:
a valve cover comprising a planar outer surface, an arcuate outer surface, and an outer shoulder, wherein the shoulder sections of the first and second segments are configured to abut against the planar outer surface, and wherein the valve cover further comprises one or more fluid openings extending into the arcuate outer surface.

14. A fluid end assembly for pumping operations, comprising:
a body comprising a plurality of bores formed therein and intersecting at a junction;
an inlet valve disposed in at least one of the bores;
an outlet valve disposed in at least one of the bores;
a valve cover coupled to the body and covering the outlet valve;
a locking assembly locking the valve cover to the body; and
a jam structure disposed at least partially between the valve cover and the locking assembly, the jam structure configured to restrict retraction of the locking assembly when a fluid flows through the outlet valve.

15. The fluid end assembly of claim 14, wherein the jam structure comprises:
a first plate;
a second plate;
a rod between the first plate and the second plate; and
one or more extensions extending relative to the second plate.

16. A fluid end assembly for pumping operations, comprising:
a locking assembly, comprising:
an actuator; and
a lock ring disposed about the actuator, and
a safety device, comprising:
a locking plate configurable in a locked position and an unlocked position, wherein the locked position prevents upward movement of the actuator; and
a coupling that couples the locking plate to the lock ring and permits the locking plate to move from the locked position to the unlocked position.

17. The fluid end assembly of claim 16, wherein:
the coupling is a swivel coupling; and
the locking plate comprises a first end and a second end, the first end coupled to the lock ring by the swivel coupling and the second end is rotatable between the locked position and the unlocked position, wherein the second end covers a portion of the actuator in the locked position.

18. The fluid end assembly of claim 16, further comprising a second coupling that couples the locking plate to the lock ring, wherein:
the locking plate comprises a first end and a second end, the first end is coupled to the coupling;
the second end coupled to the second coupling; and
the first end is coupled to the coupling, the second end is coupled to the second coupling, and a portion of the locking plate covers a portion of the actuator in the locked position.

19. The fluid end assembly of claim 18, wherein:
the second end comprises a slot;
the coupling is a swivel coupling and the second coupling is a fixed coupling; and
the slot is coupled to the fixed coupling in the locked position and the locking plate is pivoted about the swivel coupling to uncover the portion of the actuator in the unlocked position.

20. The fluid end assembly of claim 18, further comprising:
a second locking plate comprising a first end and a second end and configurable in a locked position and an unlocked position;
a third coupling coupled to the first end of the second locking plate;
a fourth coupling coupled to the second end of the second locking plate; and
the first end of the second locking plate is coupled to the third coupling, the second end of the second locking plate is coupled to the fourth coupling, and a portion of the second locking plate covers a second portion of the actuator in the locked position.
